(19) United States
(12) Patent Application Publication
(10) Pub. No.: US 2020/0173691 A1
(43) Pub. Date: Jun. 4, 2020

(54) REFLECTIVE MIRROR DEFOGGER

(71) Applicant: Shinji Mizobe, Yamaguchi (JP)

(72) Inventor: Shinji Mizobe, Yamaguchi (JP)

(21) Appl. No.: 16/744,018

(22) Filed: Jan. 15, 2020

Related U.S. Application Data
(63) Continuation of application No. PCT/JP2018/013004, filed on Mar. 28, 2018.

(30) Foreign Application Priority Data
Jul. 27, 2017 (JP) 2017-145905

(51) Int. Cl. F24S 20/61; F24S 60/10; F24S 70/60; G02B 7/18

(52) U.S. Cl. CPC F24S 20/61; G02B 7/1815; F24S 70/60; F24S 60/10

(57) ABSTRACT

A defogger defogs a reflective mirror with heat from sunlight without relying on electric power. A defogger for a reflective mirror includes a heat collector with a hollow structure to store heat from sunlight, an air inlet port through which air is fed into the heat collector, a warm-air outlet port through which air from the heat collector is discharged in a heated state, a support attached to a pole of the reflective mirror, and a connector connecting the heat collector and the support. The structure allows warm air discharged through the warm-air outlet port to come in contact with the surface of the reflective mirror to increase the surface temperature and thus defog the reflective mirror.

This application is a continuation application of International Patent Application No. PCT/JP2018/013004 filed on Mar. 28, 2018, which claims priority to Japanese Patent Application No. 2017-145905 filed on Jul. 27, 2017, the entire contents of which are incorporated by reference.

### BACKGROUND OF INVENTION

### Field of the Invention

The present invention relates to a defogger for defogging a reflective mirror installed on a road using air heated with heat from sunlight, and more particularly, to a reflective mirror defogger for defogging a reflective mirror without using electric power from a solar cell or a battery.

### Background Art

Reflective mirrors installed outdoors can be fogged or frosted in cold nights and lose their function of providing high visibility of the nearby roads for a long time. In dark situations before sunrise, vehicles travel with their headlights on and thus can recognize other vehicles with fogged or frosted reflective mirrors reflecting their headlights.

In bright situations after sunrise, however, vehicles usually travel with their headlights off and cannot recognize other vehicles with such fogged or frosted reflective mirrors, increasing the possibility of accidents.

In response to this, techniques associated with reflective mirrors have been developed to prevent or remove condensation or frost on the mirrors.

For example, Patent Literature 1 entitled ANTI-CONDENSATION ROAD MIRROR describes a road mirror including a mirror, a rear plate holding the mirror, a board including a heating wire, a solar cell, a storage battery, and a timer.

This structure can remove condensation on the mirror by energizing the heating wire.

Patent Literature 2 entitled TRAFFIC MIRROR describes a structure including a mirror and a warm-air unit for blowing warm air connected to a blowing portion, through which warm air is blown to the entire surface of the mirror.

This structure can remove condensation or frost on the mirror using warm air.

Patent Literature 3 entitled ROAD REFLECTIVE MIRROR describes a structure including an electric fan installed in the internal space of a reflective mirror, a battery, a charge/discharge control circuit, and a solar power panel for charging the battery.

This structure can prevent condensation by driving the electric fan with the battery for a predetermined period.

Patent Literature 4 entitled DEFOGGER FOR ROAD MIRROR AND ROAD MIRROR INCLUDING THE SAME describes a structure including a blower installed to blow air to the surface of a road mirror, a solar power generator, a capacitor, and a hood.

This structure can prevent fogging of the road mirror by blowing heated air to the surface of the road mirror with the blower.

Patent Literature 5 entitled MIRROR describes a structure including a mirror panel, a rear plate covering the rear surface of the mirror panel and supporting the mirror panel at its periphery, and an opening (a mirror with an opening) in at least the mirror panel or the rear plate.

This structure can prevent condensation by ventilating the space at the rear surface of the mirror panel through the opening to reduce the difference in temperature between the mirror panel and its surroundings.

### CITATION LIST

### Patent Literature

Patent Literature 1: Japanese Unexamined Patent Application Publication No. 7-268820

Patent Literature 2: Japanese Unexamined Utility Model Registration Application Publication No. 63-31113

Patent Literature 3: Japanese Unexamined Patent Application Publication No. 2011-231573

Patent Literature 4: Japanese Unexamined Patent Application Publication No. 2011-202435

Patent Literature 5: Japanese Unexamined Patent Application Publication No. 2005-290667

### SUMMARY OF INVENTION

### Technical Problem

The known structure described in Patent Literature 1 includes components including the solar cell, the storage battery, the board including the heating wire, and thus increases the cost for manufacturing the road mirror, as well as involves subsequent maintenance for the complex equipment.

Further, the structure described in Patent Literature 1 uses electricity, and thus is designed to be waterproof for outdoor use of the reflective mirror. The issue of being waterproof also applies to Patent Literatures 2 to 4 described later.

The structure described in Patent Literature 2 includes the air-blowing unit and the heater to feed warm air, and thus increases the cost for manufacturing the mirror. Moreover, the warm-air unit operates depending on the outside air temperature irrespective of condensation or frost, and thus consumes more electric power than needed and degrades more quickly.

The structure described in Patent Literature 3 includes the solar panel and the battery, and thus increases the cost for manufacturing the reflective mirror. Moreover, when the battery is charged insufficiently, the structure cannot provide anti-condensation.

The structure described in Patent Literature 4 includes the solar power generator and the capacitor, and thus increases the cost for manufacturing the road mirror. Moreover, when the capacitor is charged insufficiently, the structure cannot provide anti-condensation.

The structure described in Patent Literature 5 is simple, can be manufactured at low cost, and is maintenance-free. However, the structure solely relying on natural outside air flow has the anti-condensation affected by the wind. Typically, condensation or frost is more likely under fine weather conditions with no wind or gentle breeze, and is less likely in rainy or windy conditions. With condensation or frost more likely under such weather conditions with no wind or gentle breeze, the structure in Patent Literature 5 solely using natural outside air flow prevents condensation inefficiently.

In response to such issues, one or more aspects of the present invention are directed to a reflective mirror defogger using heat from sunlight without relying on electric power.

### Solution to Problem

A first aspect of the present invention provides a defogger for defogging a reflective mirror using air heated with heat from sunlight including a heat collector having a hollow structure and located below the reflective mirror, an air inlet port and a warm-air outlet port in the heat collector that are located below the reflective mirror, a support attached to a pole of the reflective mirror, and a connector connecting the support and the heat collector. The warm-air outlet port is located above the air inlet port to allow air in the heat collector to ascend for feeding or discharging air in or out the heat collector when the air is heated by heat from sunlight absorbed by the heat collector, without a device including a fan for feeding or discharging air in or out the heat collector.

In the structure according to the first aspect, air fed into the heat collector through the air inlet port is heated by heat from sunlight into warm air, which is discharged through the warm-air outlet port and then ascends along the surface of the reflective mirror. This increases the surface temperature of the reflective mirror for defogging the surface.

A second aspect of the present invention provides the reflective mirror according to the first aspect in which the heat collector includes a plurality of hollow pipes arranged in parallel.

In addition to producing the effects of the first aspect, the structure according to the second aspect efficiently heats air in the hollow pipes with the heat collector.

A third aspect of the present invention provides the reflective mirror according to the first or second aspect including a warm-air guide having a hollow structure with an open distal end and an open basal end. The guide extends upward from a warm-air outlet port to which the basal end is connected.

In addition to producing the effects of the first or second aspect, the structure according to the third aspect guides, with the warm-air guide, the warm air resulting from the air in the heat collector heated by the solar heat, and then efficiently feeds the warm air to below the reflective mirror.

A fourth aspect of the present invention provides the defogger according to any one of the first to third aspects, further including a warm-air guide assist including a transparent plate. The warm-air guide assist guides warm air discharged through the warm-air outlet port to below the reflective mirror with the heat collector located below the reflective mirror.

In addition to producing the effects of any one of the first to third aspects, the structure according to the fourth aspect allows warm air discharged through the warm-air outlet port to easily ascend along the surface of the reflective mirror, and thus efficiently heats the entire surface of the reflective mirror with the warm air.

### Advantageous Effects

As described above, the structure according to the first aspect can defog a reflective mirror without using electric power from a solar cell or a battery.

The structure without using electric power as described above is simple, uses no electric wiring, and can be manufactured safely at low cost, and also is maintenance-free with no parts like a battery to be replaced after a predetermined period of use.

The support connected to the heat collector with the connector is attached to the pole to allow easy installation of the heat collector on the reflective mirror with the warm-air outlet port located below the reflective mirror.

In addition to producing the advantageous effects of the first aspect, the structure according to the second aspect allows air to flow through the hollow pipes to efficiently heat the air in the hollow pipes, and allows warmer air to be discharged through the warm-air outlet ports.

In addition to producing the advantageous effects of the first or second aspect, the structure according to the third aspect can efficiently feed the warm air heated with heat from sunlight and discharged from the heat collector, and thus defog the reflective mirror in a shorter time.

The warm-air guide formed from a flexible material can be twisted to easily feed the warm air from the heat collector to below the reflective mirror when the reflective mirror and the heat collector have front surfaces in different directions.

In addition to producing the advantageous effects of any one of the first to third aspects, the structure according to the fourth aspect can efficiently heat the entire surface of the reflective mirror using warm air discharged through the warm-air outlet port and ascending along the surface of the reflective mirror, and thus defog the reflective mirror in a shorter time.

### BRIEF DESCRIPTION OF THE DRAWINGS

FIG. 1A is an external perspective view of a reflective mirror defogger according to a first embodiment of the present invention, and FIG. 1B is an enlarged cross-sectional view of the defogger taken along line A-A in FIG. 1A.

FIGS. 2A and 2B are diagrams showing example locations of air inlet ports in a heat collector.

FIG. 3 is an external perspective view of a reflective mirror defogger according to a second embodiment of the present invention.

FIG. 4 is an external perspective view of a reflective mirror defogger according to a third embodiment of the present invention.

FIG. 5 is an external perspective view of a reflective mirror defogger according to a fourth embodiment of the present invention.

FIG. 6 is an external perspective view of a reflective mirror defogger according to a fifth embodiment of the present invention.

### DETAILED DESCRIPTION

A reflective mirror defogger according to first to fifth embodiments of the present invention will be described in detail. The term fogging herein refers to the reflective mirror with condensation or frost on the surface lowering visibility. The term defogging the reflective mirror thus includes removing condensation or frost from the reflective mirror. The term below the reflective mirror includes a range below a lower end of the reflective mirror and also a range of 30 cm above from the lower end of the reflective mirror. Although a reflective mirror described herein is circular, the mirror may be a quadrangular reflective mirror on which a reflective mirror defogger according to one or more embodiments of the present invention may be installed.

### First Embodiment

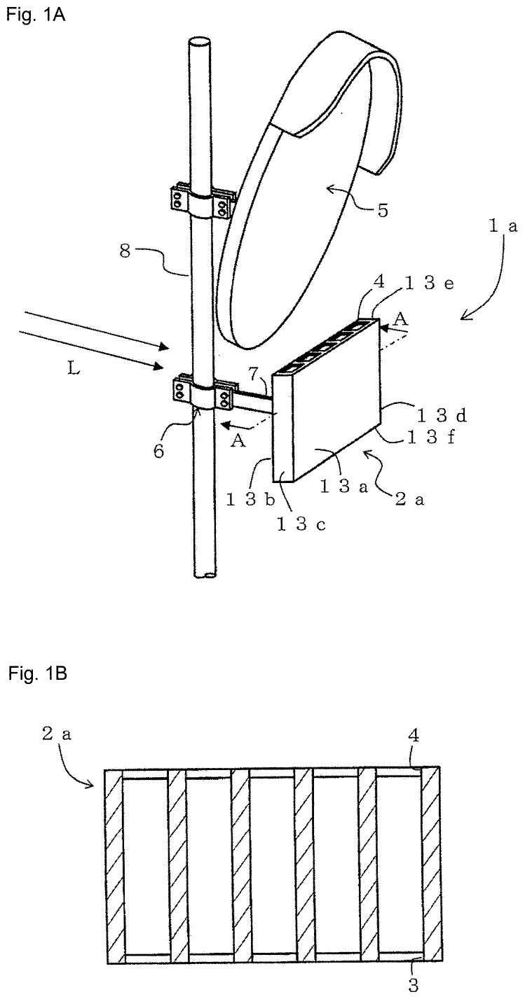

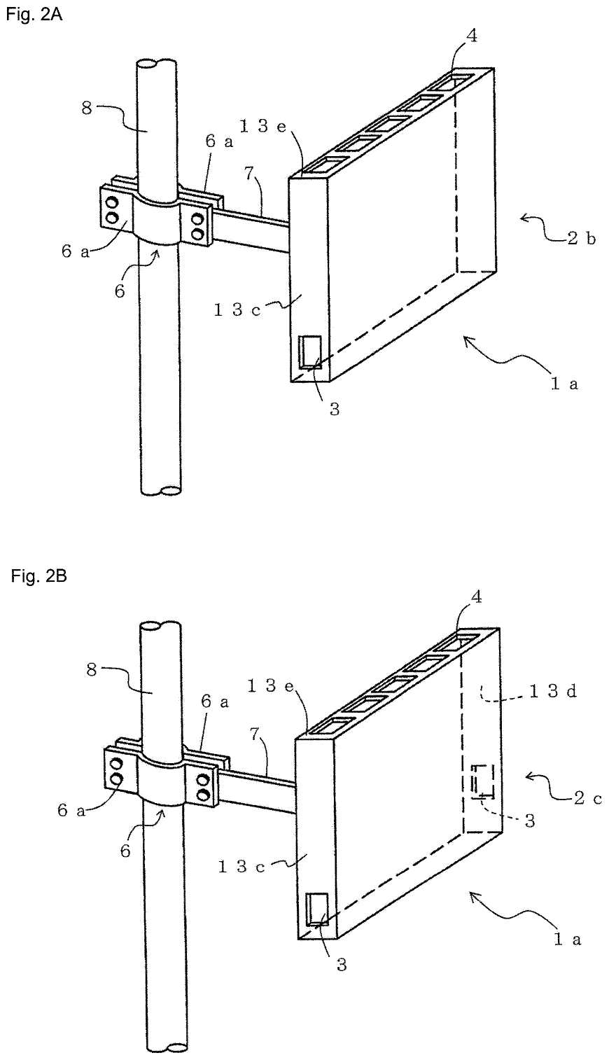

FIG. 1A is an external perspective view of an example reflective mirror defogger according to one or more embodiments of the present invention installed on a reflective mirror. FIG. 1B is an enlarged cross-sectional view of the defogger taken along line A-A in FIG. 1A. FIGS. 2A and 2B show example locations of air inlet ports in a heat collector.

As shown in FIGS. 1A and 1B, a reflective mirror defogger 1a according to one or more embodiments of the present invention includes a heat collector 2a with a hollow structure to store heat from sunlight L, air inlet ports 3 through which air is fed into the heat collector 2a, warm-air outlet ports 4 through which air from the heat collector 2a is discharged in a heated state, a support 6 attached to a pole 8 of a reflective mirror 5, and a connector 7 connecting the heat collector 2a and the support 6.

More specifically, the reflective mirror defogger 1a allows warm air discharged through the warm-air outlet ports 4 to come in contact with the surface of the reflective mirror 5 to increase the surface temperature and thus defog the reflective mirror 5.

The heat collector 2a is a cuboid with a rectangular cross section. The heat collector 2a accommodates multiple pipes connecting the air inlet ports 3 and the warm-air outlet ports 4 to each other to store heat by absorbing heat energy from the sunlight L. The hollow structure in one or more embodiments of the present invention refers to a structure with a space in which air can stay temporarily.

The heat collector 2a is installed with its rear surface 13b substantially perpendicular to the direction in which the sunlight L radiates. Thus, air in the heat collector 2a is heated with the sunlight L incident on the outer surfaces or an inner front surface 13a of the heat collector 2a.

The surfaces of the heat collector 2a and at least part of a warm-air guide 11 (described below) may be formed from a heat-absorbing material.

Examples of such a heat-absorbing material include metal such as aluminum, silver, and copper, steel such as stainless steel, heat-resistant steel, alloy steel, and carbon steel, nitride ceramics such as aluminum nitride, silicon nitride, and boron nitride, carbide ceramics such as silicon carbide, zirconium carbide, and tantalum carbide, and oxide ceramics such as silica and alumina.

At least part of each surface of the heat collector 2a may be covered with a sheet or paint with a light-absorbing dark color, such as black, grey, or brown. At least part of each surface of the heat collector 2a may be rough or wavy to increase the surface area.

The rear surface 13b of the heat collector 2a may be formed from, for example, a transparent acrylic resin or glass that is less likely to dissipate heat. This structure reduces heat dissipation from the front surface 13a when the sunlight L is incident on the inner front surface 13a of the heat collector 2a, and thus can heat air efficiently in the heat collector 2a. The inner front surface 13a of the heat collector 2a (inner surface of the heat collector 2a) formed from a heat-absorbing material will be more effective.

Air in the heat collector 2a can be more efficiently heated when the outer peripheral surfaces of the heat collector 2a other than the rear surface 13b, or for example, the surfaces in contact with outside air including the front surface 13a, side surfaces 13c and 13d, an upper surface 13e, and a bottom surface 13f, are covered with a thermal insulator such as polyurethane foam, polystyrene foam, wood, or glass wool.

The bottom surface 13f of the heat collector 2a has at least one air inlet port 3, which is an opening through which air is fed into the heat collector 2a. The air inlet port 3 may be in the shape of, for example, a quadrangle such as a rectangle or square, or a circle such as an ellipse or perfect circle. The air inlet port 3 may be formed in either or both of the side surfaces of the heat collector 2a.

For example, as shown in FIG. 2A, the air inlet port 3 formed in the side surface 13c perpendicular to the upper surface 13e having the warm-air outlet ports 4 lowers the likelihood that air fed from the air inlet port 3 into a heat collector 2b moves straight and is directly discharged out of the heat collector 2b through the warm-air outlet ports 4. This structure allows air to stay longer in the heat collector 2b.

For example, as shown in FIG. 2B, the air inlet ports 3 formed in the side surfaces 13c and 13d of the heat collector at locations spaced by different distances from the end connected to the upper surface 13e lower the likelihood that air fed from one of the air inlet ports 3 into the heat collector 2c is directly discharged through the other air inlet port 3. This structure allows air to stay longer in a heat collector 2c.

In the heat collectors 2a to 2c, the warm-air outlet ports 4 may be formed in upper portions of the side surface 13c or 13d, instead of the upper surface 13e. Air ascends when warmer than the surrounding air. Thus, air in the heat collectors 2a to 2c with the warm-air outlet ports 4 in the upper surface 13e or in the upper portions of the side surfaces 13c and 13d can be discharged without using a device such as a fan for discharging air from the heat collectors 2a to 2c.

As the air in the heat collectors 2a to 2c is discharged through the warm-air outlet ports 4, air outside the heat collectors 2a to 2c is drawn into the heat collectors 2a to 2c through the air inlet ports 3. This structure eliminates a device such as a fan for feeding air into the heat collectors 2a to 2c. The warm-air outlet ports 4 may be at least one, and may have the shape of, for example, a quadrangle such as a rectangle or square, or a circle such as an ellipse or perfect circle.

A porous heat collecting material such as an open-cell foam or a carbon fiber sheet may be located on the heat collectors 2a to 2c. This structure allows air to stay longer in the heat collectors 2a to 2c.

Partitions may be installed in the heat collectors 2a to 2c to define a zigzag air flow path (not shown). This structure allows air to stay longer in the heat collectors 2a to 2c, and can heat air efficiently.

Typical reflective mirrors on the road have a diameter of 45 to 100 cm. The upper surface 13e and the bottom surface 13f of each of the heat collectors 2a to 2c may have a length of 20 to 110 cm and a width of 1 to 10 cm, and the side surfaces 13c and 13d may have a length of 15 to 100 cm.

The support 6 includes a connector 7 connected to the rear surface 13b of each of the heat collectors 2a to 2c, and a pair of supporters 6a fixed to the connector 7. Each of the heat collectors 2a to 2c is attached to, with the support 6, a pole 8 of the reflective mirror 5 having a lower end buried underground with the warm-air outlet ports 4 located below the reflective mirror 5.

The supporters 6a are fixed to the reflective mirror 5 with bolts and nuts, but may be fixed with any other known fasteners. The heat collectors 2a to 2c may be installed with the rear surface 13b facing east to southeast to enhance the heat collection effect. The support 6 may have a rotary portion to adjust the orientation of the heat collectors 2a to 2c.

### Second Embodiment

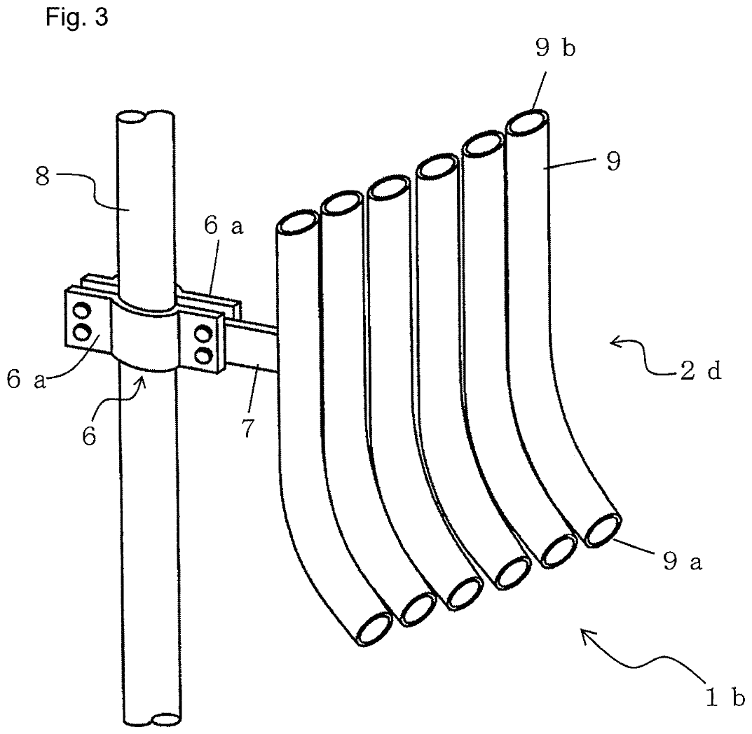

FIG. 3 is an external perspective view of a reflective mirror defogger according to a second embodiment. The components shown in FIG. 3 are given the same reference numerals in FIG. 1, and will not be described.

A reflective mirror defogger 1b according to the present embodiment includes a heat collector 2d including multiple pipes 9 connected in parallel. The pipes 9 are formed from the heat-absorbing material described above, and have an inner diameter of 0.5 to 10 cm. Each pipe 9 has a lower end 9a as the air inlet port 3 and an upper end 9b as the warm-air outlet port 4.

The pipes 9 may be helical. This structure allows air to stay longer in the heat collector 2d.

### Third Embodiment

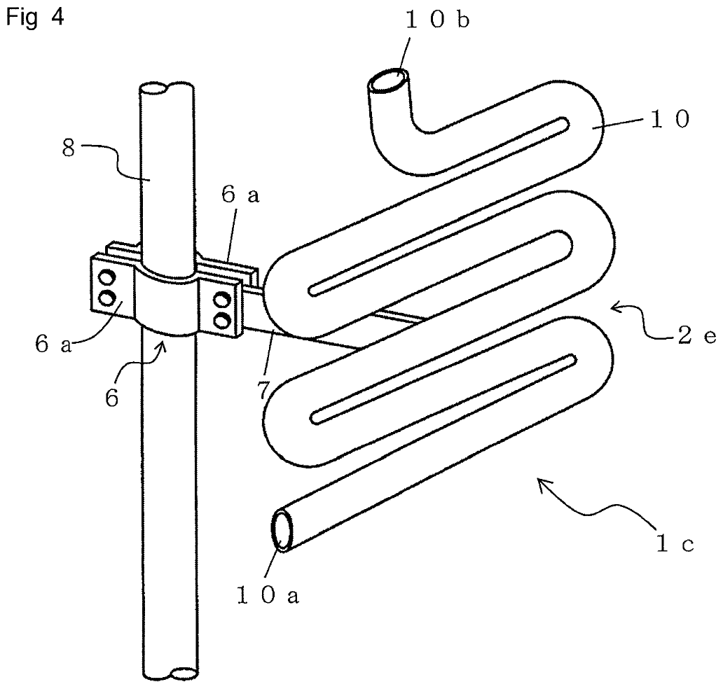

FIG. 4 is an external perspective view of a reflective mirror defogger according to a third embodiment. The components shown in FIG. 4 are given the same reference numerals in FIG. 1, and will not be described.

A reflective mirror defogger 1c according to the present embodiment includes a heat collector 2e including a single serpentine pipe 10. The pipe 10 has a lower end 10a as the air inlet port 3 and an upper end 10b as the warm-air outlet port 4.

This structure allows air to stay still longer in the heat collector 2e, and can heat air efficiently. In some embodiments, the upper end 10b of the pipe 10 may be closed and an opening may be formed at a nearby position on the upper surface to serve as the warm-air outlet port 4.

### Fourth Embodiment

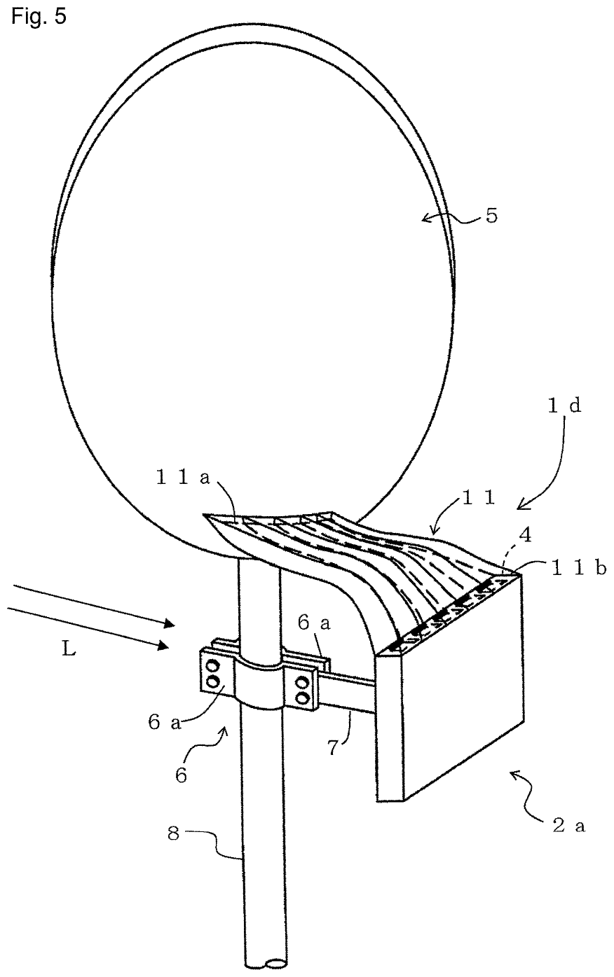

FIG. 5 is an external perspective view of a reflective mirror defogger according to a fourth embodiment, showing the reflective mirror defogger 1a according to the first embodiment additionally including a warm-air guide 11. The components shown in FIG. 5 are given the same reference numerals in FIG. 1, and will not be described.

A reflective mirror defogger 1d according to the present embodiment includes the warm-air guide 11 having a hollow structure with open distal ends 11a and open basal ends 11b and extending upward from the warm-air outlet ports 4 to which the basal ends 11b are connected.

This structure guides air heated in the heat collector 2a locally to below the reflective mirror 5.

The warm-air guide 11 formed from a deformable member may be twisted to guide the warm air discharged through the warm-air outlet ports 4 to below the reflective mirror 5 when the reflective mirror 5 and the heat collector 2a have front surfaces in different directions.

### Fifth Embodiment

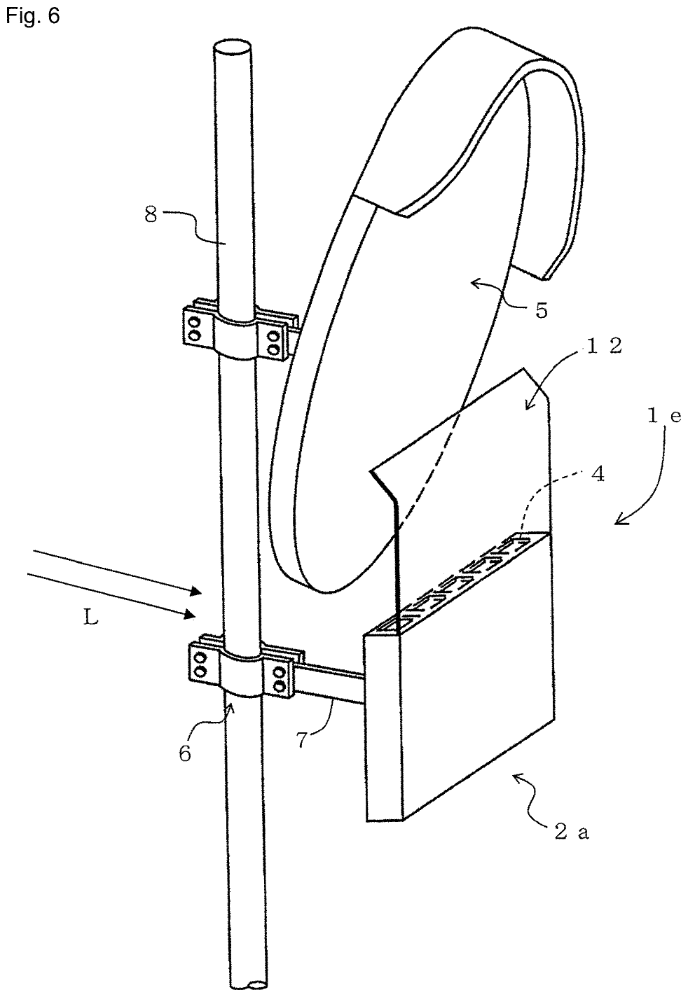

FIG. 6 is an external perspective view of a reflective mirror defogger according to a fifth embodiment, showing the reflective mirror defogger 1a according to the first embodiment including a warm-air guide assist 12. The components shown in FIG. 6 are given the same reference numerals in FIG. 1, and will not be described.

A reflective mirror defogger 1e according to the present embodiment includes the warm-air guide assist 12 above the warm-air outlet ports 4. The warm-air guide assist 12 is formed from a transparent plate, and guides the warm air discharged through the warm-air outlet ports 4 to below the reflective mirror 5 to allow the air to ascend along the surface of the reflective mirror 5.

This structure allows the warm air discharged through the warm-air outlet ports 4 to ascend along the surface of the reflective mirror 5 to efficiently heat the entire surface of the reflective mirror 5, and thus defog the reflective mirror 5 in a shorter time. The warm-air guide assist 12 is formed from a transparent plate and thus does not block an image reflected on the reflective mirror 5.

The warm-air guide assist 12 may be located at the upper end of the warm-air guide 11, instead of the warm-air outlet ports 4. The surface of the warm-air guide assist 12 treated with water-repellent coating or other treatment for waterdrop repellence can be defogged. The warm-air guide assist 12 covers the surface of the reflective mirror 5, or particularly a lower portion of the reflective mirror 5, and thus may have a height of, for example, about 5 to 50 cm.

### INDUSTRIAL APPLICABILITY

The reflective mirror defogger according to the embodiments is usable as an outdoor road reflective mirror defogger.

### REFERENCE SIGNS LIST

1a reflective mirror defogger
1b reflective mirror defogger
1c reflective mirror defogger
1d reflective mirror defogger
1e reflective mirror defogger
2a heat collector
2b heat collector
2c heat collector
2d heat collector
2e heat collector
3 air inlet port
4 warm-air outlet port
5 reflective mirror
6 support
6a supporter
7 connector
8 pole
9 pipe
9a lower end
9b upper end
10 pipe
10a lower end
10b upper end
11 warm-air guide
11a distal end
11b basal end
12 warm-air guide assist
13a front surface
13b rear surface
13c side surface
13d side surface
13e upper surface
13f bottom surface
L sunlight

1. A defogger for defogging a reflective mirror using air heated with heat from sunlight, the defogger comprising:
a heat collector having a hollow structure and located below the reflective mirror;
an air inlet port and a warm-air outlet port in the heat collector, the air inlet port and the warm-air outlet port being located below the reflective mirror;
a support attached to a pole of the reflective mirror; and
a connector connecting the support and the heat collector,
wherein the warm-air outlet port is located above the air inlet port to allow air in the heat collector to ascend for feeding or discharging air in or out the heat collector when the air is heated by heat from sunlight absorbed by the heat collector.

2. The defogger according to claim 1, further comprising:
a warm-air guide assist including a transparent plate and configured to guide warm air discharged through the warm-air outlet port to below the reflective mirror with the heat collector located below the reflective mirror.
